(19) United States
(12) Patent Application Publication
(10) Pub. No.: US 2008/0010279 A1
(43) Pub. Date: Jan. 10, 2008

(54) Computerized tracking of educational accountability reporting and appeals system

(75) Inventors: Wade J. Lykkehoy, Plymouth, MN (US); Kimberly Ann Caywood, Ramsey, MN (US)

Correspondence Address: SCHWEGMAN, LUNDBERG & WOESSNER, P.A., P.O. BOX 2938, MINNEAPOLIS, MN, 55402, US

(73) Assignee: Data Recognition Corporation

(21) Appl. No.: 11/821,558

(22) Filed: Jun. 22, 2007

Related U.S. Application Data
(60) Provisional application No. 60/805,687, filed on Jun. 23, 2006.

(51) Int. Cl. G06F 7/06

(52) U.S. Cl. 707/6; 434/354

(57) ABSTRACT

This document discusses, among other things, a system and method for tracking of educational accountability reporting for Federal, State, and local initiatives such as the Federal No Child Left behind (NCLB) program. The system also includes a detailed process for handling appeals and reconsiderations of disputed assessment or demographic data being utilized for the calculation of statistics such as NCLB's Adequate Yearly Progress (AYP).

### CROSS-REFERENCE TO RELATED APPLICATION(S)

This application claims the benefit of U.S. Provisional Application Ser. No. 60/805,687, filed Jun. 23, 2006, under 35 U.S.C. 119(e), which is incorporated herein by reference in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2006, Data Recognition Corporation All Rights Reserved.

### TECHNICAL FIELD

This patent document pertains generally to, computerized processes and apparatus for education, and more particularly to computerized tracking of educational accountability reporting and appeals system.

### BACKGROUND

The Federal Government's No Child Left Behind (NCLB) provides an opportunity to measure Adequate Yearly Progress (AYP) towards the improvement goals set forth in the NCLB legislation. A variety of different combinations of data are required to fulfill different reporting needs. Depending on the jurisdiction, a number of different measures of compliance, including standardized test results for example, need to be accumulated and tracked. It can be difficult to collate data from disparate databases to provide the desired combinations.

There is a need in the art to provide AYP reports. Such reporting requires the accumulation and analysis of large amounts of testing, attendance and demographic data from every individual student within a school system. There is also a need in the art for handling of cases where appeals of resulting reports are initiated.

### SUMMARY

The above-mentioned problems and others not expressly discussed herein are addressed by the present subject matter and will be understood by reading and studying this specification.

Disclosed herein, among other things, is a method for computerized tracking of educational accountability reporting and appeals. Collected data is stored relating to student information for at least one school and at least one school district. A plurality of rules are applied to the information to generate a score indicative of progress for at least one school and at least one district. Appeals are processed relating to the score. Appeal information is electronically mailed to one or more users. According to an embodiment, the stored data is searched to obtain rule compliance data for the student information.

Disclosed herein, among other things, is a system for tracking educational accountability reporting and appeals. According to an embodiment, the system includes an electronic database of information relating to student information for at least one school and at least one school district or system. The information includes enrollment rate, dropout rate, attendance data and assessment data from standardized testing results. The system embodiment also includes a computer processor adapted to apply a plurality of rules to the information to generate a score indicative of progress for the at least one school and at least one district. The processor is further adapted to process appeals and to electronically mail appeal information to one or more users. According to an embodiment, the database is adapted to be searchable to provide rule compliance data for the student information.

This Summary is an overview of some of the teachings of the present application and not intended to be an exclusive or exhaustive treatment of the present subject matter. Further details about the present subject matter are found in the detailed description and appended claims. The scope of the present invention is defined by the appended claims and their legal equivalents.

### BRIEF DESCRIPTION OF THE DRAWINGS

FIG. 1 shows an accountability reporting system, according to one embodiment of the present subject matter.

FIG. 2 shows an online corrections system—student update system, according to one embodiment of the present subject matter.

FIG. 3 shows an online corrections system—district sign-off system, according to one embodiment of the present subject matter.

FIG. 4 shows an online potential match system, according to one embodiment of the present subject matter.

FIG. 5 shows a flow diagram of an adequate yearly progress (AYP) appeal/reconsideration process, according to one embodiment of the present subject matter.

FIG. 6 shows a schematic diagram of a web-based computer client-server system for implementing an adequate yearly progress (AYP) appeal/reconsideration process, according to one embodiment of the present subject matter.

FIG. 7 shows a schematic diagram of a client system, according to one embodiment of the present subject matter.

FIG. 8 shows a schematic diagram of a server system, according to one embodiment of the present subject matter.

### DETAILED DESCRIPTION

The following detailed description includes references to the accompanying drawings, which form a part of the detailed description. The drawings show, by way of illustration, specific embodiments in which the invention may be practiced. These embodiments are described in enough detail to enable those skilled in the art to practice the invention. Other embodiments exist without departing from the scope of the present invention. The following detailed description is, therefore, not to be taken in a limiting sense, and the scope of the present invention is defined by the appended claims and their legal equivalents.

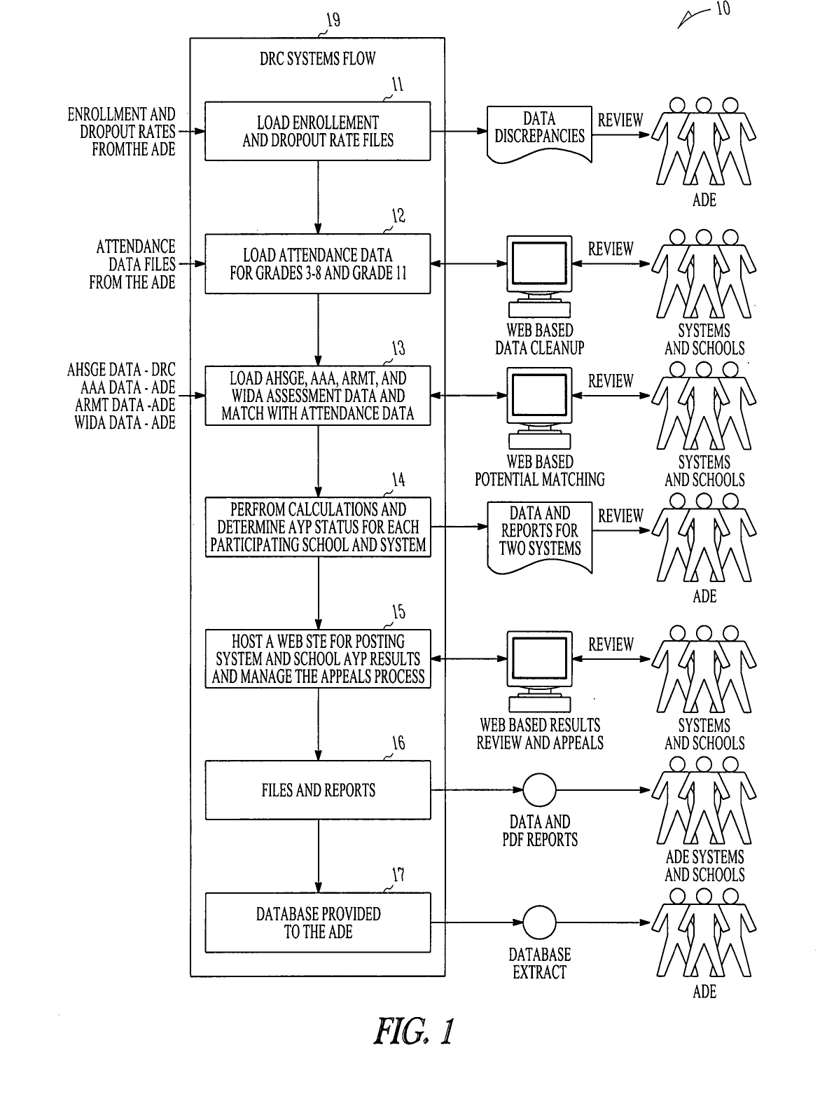

FIG. 1 shows an accountability reporting system 10, according to one embodiment of the present subject matter. The system includes a flowchart 19 having steps for providing an accountability reporting and appeal system that is capable of tracking Adequate Yearly Progress (AYP) and other school and student assessment measures. While one embodiment of a process for managing the accountability reporting system is shown, other embodiments including other states, grade levels, and/or standardized tests are possible without departing from the scope of this disclosure. In the diagram, ADE refers to the Alabama Department of Education and SQA refers to Software Quality Assurance. It will be apparent to one of skill in the art that, while the state of Alabama is used as an example embodiment, other educational jurisdictions and corresponding student assessment measures can be used without departing from the scope of this disclosure.

Load Enrollment and Dropout Rate Files into the Database (Step 11 in FIG. 1)

First, the enrollment file and dropout rate file are loaded into the database. To help ensure valid and complete data, a series of checks against the data are performed. The school district is notified of any discrepancies. According to an embodiment, the checks are based on a set of business rules defined within the system and editable by the individual school district. Pre-defined business rules include, but are not limited to: (1) all schools that have tested throughout the school year are present in the appropriate loaded data files—for high schools, this check can be performed immediately—for middle and elementary schools, this check is performed upon receipt of the ARMT (Alabama Reading and Mathematics Test) data; (2) all schools in the loaded data files have test data.

Load Attendance Data for Specific Grade Levels into the Database and Provide Schools and Systems the Opportunity to Correct the Data. (Step 12 in FIG. 1)

Second, the attendance files for specific grade levels are loaded into the database. For example, grades 3-8 and 11 are used in Alabama. As with the above data files, again a series of checks against the data are performed, immediately informing the school district of any discrepancies. These checks are based on a set of business rules defined within the system. Predefined business rules include, but are not limited to: (1) all schools that have tested at least one student at the designated grade level are present in the data file; (2) test history exists in the current match-back database for all schools in the data file; (3) Number of students within each district/school is within 10 percent of prior school year.

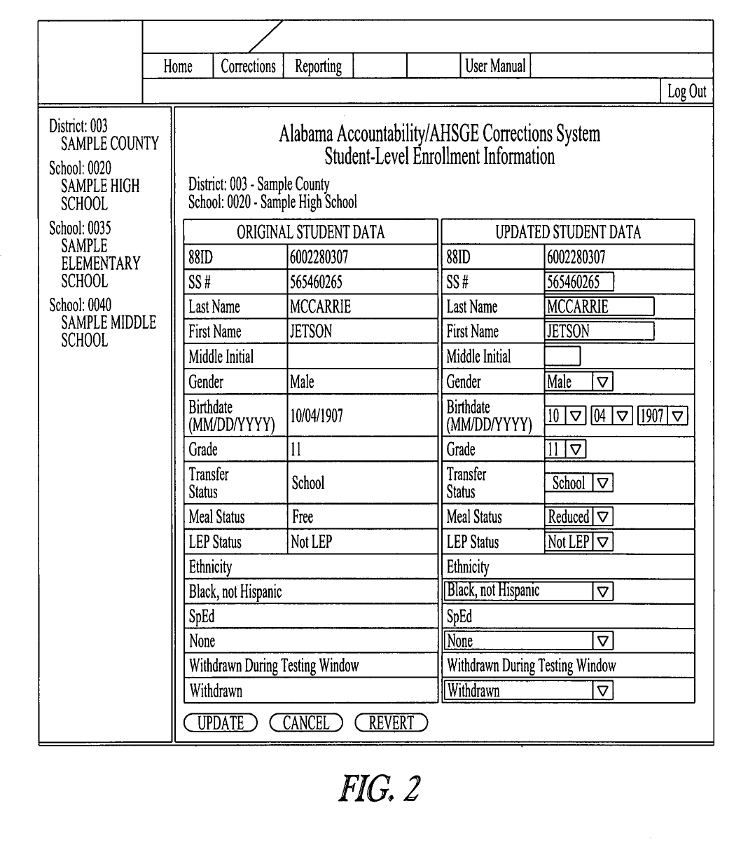

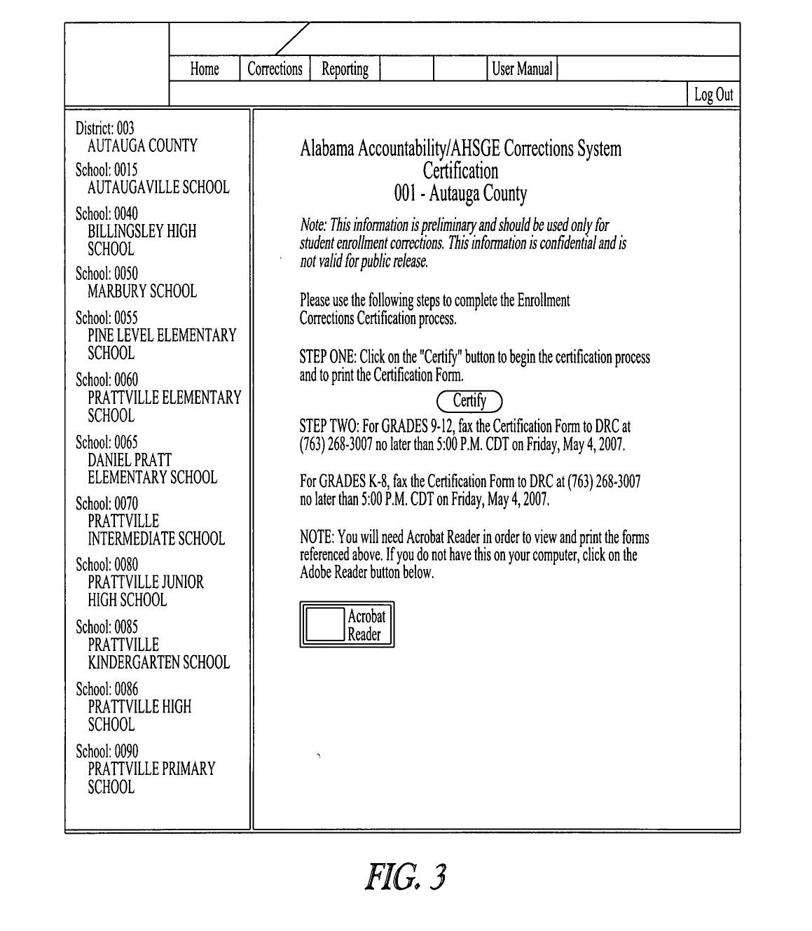

Upon loading this information into the database, the attendance data for a specific grade level is available via a secure website for review and correction by system and school personnel. The system can e-mail designated district/school personnel that the data is available for review and the end date for making changes, according to various embodiments. During this period, the data can be edited multiple times allowing changes to student data, especially those specific to NCLB requirements. After the end-date, the system displays data in a read-only mode that does not allow changes to be made. This embodiment includes a web-based data review and correction system that is convenient, secure, and easy to use. FIGS. 2 and 3 show screen shots of an embodiment of the web-based data review and correction system.

According to various embodiments, a standard set of functional capabilities of the system include, but are not limited to: data are displayed in a student roster format, listing all students within a system, organized by school; displayed data include student demographics: both original values and modified values; systems and schools are allowed to make corrections online; retrieval and display of data are based on valid security access (a school can only see its data; likewise, a system can only see its data and its schools' data); each system is provided the ability to “sign-off” that their data is correct; jointly defined business rules, such as not allowing blank values, valid data values/ranges, are enforced; a student roster is generated which lists each student's demographic data; student data can be updated multiple times; data is displayed as read-only when the update window closes; and web pages are operational in both a Windows and Mac environment.

An embodiment of the system includes online user manual details usage of the system. In addition, a Customer Service Call Center is available to provide personal assistance. Data for additional grades follows the same process as described above.

Load Assessment Data (Step 13 in FIG. 1)

In an embodiment, using the state of Alabama for an example, assessment data includes standardized testing results for AHSGE (Alabama High School Graduation Exam), ARMT, AAA (Alabama Alternate Assessment), and. This standardized testing data is loaded into the database, matched with attendance data, and provided to schools and systems with the opportunity to review and confirm potential matches. After 2005, results from the ADAW (Alabama Direct Assessment of Writing) may also be included. In some jurisdictions, WIDA (World-class Instructional Design and Assessment) results may also me incorporated.

This embodiment processes the AHSGE test data, thus provide immediate access to these data. The system leverages the existing student demographic matching process, which is based on the following data elements in an embodiment: SSN (Social Security Number); state student identification number; Last Name; First Name (first 5 characters, in an embodiment); Gender; and date of birth. In various embodiments, database matches are determined by applying the following rules in this order: (1) All of the above demographic data elements match exactly; (2) SSN plus 3 of any of the remaining demographic data elements match exactly; (3) SSN plus 2 of any of the remaining demographic data elements match exactly; (4) SSN is off by 1 or 2 digits plus all 4 remaining demographic data elements match exactly.

For any students who remain unmatched, the system applies a second set of rules to identify potential matches. Here, also, the system leverages the existing potential matching process. According to an embodiment, demographic data elements used in the potential matching process include the following: School, Last Name, First Name (first 5 characters in an embodiment); Gender; and date of birth. According to various embodiments, potential matches are determined by applying the following rules in this order: (1) all of the above demographic fields match exactly; (2) school plus 3 of any of the remaining demographic fields match exactly; (3) school plus 2 of any of the remaining demographic fields match exactly; and (4) all fields excluding School match exactly.

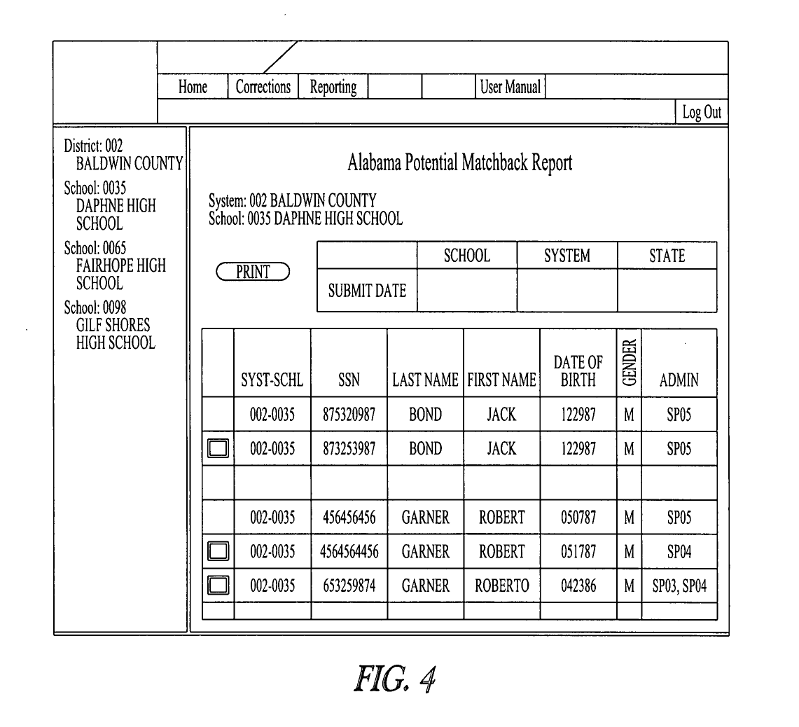

Potential matches can be posted online via a secure website for review and confirmation, in an embodiment. Systems and schools can review the potential matches, confirming matches that should be made in the database. The system can send an e-mail to identified system/school personnel informing them that the data are available for review as well as the end date for confirming matches, in an embodiment. An online user manual can be provided, detailing usage of the system. In addition, a Customer Service Call Center is available to provide assistance. FIG. 4 shows a screen shot from the potential match system that is part of this embodiment.

At the end of the potential match window (time period), the confirmed matches are applied to the database, linking together the student's demographics from the attendance data with their AHSGE (or any other support assessment data sets) test results.

Upon receipt of the ARMT and AAA data, the same process used for the AHSGE data as described above is followed. The data is matched against the attendance data using the same rules. Potential matches are identified and posted on our secure website for review and confirmation. If the school district determines that ADAW data is to be included in subsequent years, the same process is followed to load, match, and resolve potentials for that data.

Perform Calculations and Determine AYP Status for Each Participating School and System. (Step 14 in FIG. 1)

The system calculates each individual states proficiency targets for specific grade levels (for example: grades 3, 5, and 7 in reading and for grades 3, 5, 7, and 8 in mathematics) for all students and subgroups at the school, system, and state levels. The formula to be used for this calculation is determined by reviewing each state's accountability workbook and in the accountability system interpretative guide (or some similar state administrative documentation for this type of assessment). In this embodiment, data from 2005 was used for this calculation. The calculated proficiency targets are reviewed with each individual school district prior to AYP calculations and report generation.

This embodiment also specifies that, the number of students who score proficient or advanced (Levels III or IV) on an alternate achievement assessment cannot exceed 1% of all students in the grades tested at the district or state level. If within a district or the state this 1% cap is exceeded, the system calculates the number of students over the 1% cap. This number of students is randomly selected from the students scoring proficient or advanced and counted at the lowest proficiency level (Level 1) on all calculations at the district, and state level. The system can be configured so that first-year LEP students are excluded, and, hence, not counted, for calculation of participation and AYP in reading and mathematics. The state can override the 1% cap for a district, in an embodiment.

At this point in the process, the system has all of the data necessary to perform preliminary calculations, AYP status determination, and report generation for the two systems the school district wishes to use for data checking. The following list summarizes calculations to be performed, according to various embodiments: (1) percent and number of students performing at a proficient achievement level in reading and mathematics in grades 3-8 and 11; (2) percent and number of students performing at a proficient achievement level in writing in grades 5, 7, and 11; (3) percent and number of students performing at a proficient achievement level in science in grades 5, 7 and 11; (4) percent and number of students for the subgroups of special education students, American Indian/Alaskan Native, Asian/Pacific Islander, Black, Hispanic, White, limited English proficient, and free/reduced lunch performing at a proficient achievement level in reading and mathematics in grades 3-8 and 11; (5) percent and number of students for the above subgroups performing at a proficient achievement level in writing in grades 5, 7, and 10; (6) percent and number of students for the above subgroups performing at a proficient achievement level in science in grades 5, 7, and 11; (7) percent and number of students passing all subject-areas of the AHSGE (for the Alabama embodiment) in grade 12; (8) rate of participation for all students in reading and mathematics for grades 3-8 and 11; (9) participation rate for the above subgroups in reading and mathematics for grades 3-8 and 11; (10) number of special education students enrolled in grades 3-8 and 11 for each system ; (11) one percent of the number of students enrolled in grades 3-8 and 11 for each system; (12) number of special education students in grades 3-8 and 11 performing at proficient achievement level on the AAA (for the Alabama embodiment).

In this embodiment, the calculation engine facilitates modification and additions. Additionally, calculation engine retains intermediate results for use by a school district in data checking and for use by the districts/schools in understanding how their AYP calculations resulted in their AYP status.

Host a Website for Posting School and System AYP Results and Managing the Appeals Process. (Step 15 in FIG. 1)

Upon approval of the two data checking systems, the system can calculate data, determine AYP status, and generate reports for all participating schools, systems, and the state. In an embodiment, the system then publishes the results to an integrated user-friendly web-based system to facilitate school and system staff's review of their AYP status, their understanding of the calculations and data behind the status, and the ability for systems to initiate an appeal on data or a status they question. The web-interface allows users to create and produce reports that are informative and easy to understand and interpret by schools, systems, and the state. According to various embodiments, this system hosts: (1) AYP status summary with interactive drill-down capability, which shows the underlying calculations and summary data; (2) accountability status report; (3) calculation worksheet in PDF format; (4) data file; (5) appeals. According to an embodiment, the accountability status report and calculation worksheet are provided in PDF format.

According to various embodiments, the AYP status summary provides data on whether the school/system/state has met: proficiency targets on the state assessments in reading and mathematics; proficiency targets, using confidence intervals, on state assessments in reading and mathematics, if needed; proficiency targets, using uniform averaging, on state assessments in reading and mathematics, if needed; Safe Harbor in reading and mathematics, if needed; a 95% (or other programmable) participation rate; goals on the state assessments in science for specific grade levels (such as grades 5, 7, and 11); goals on the state assessments in writing for specific grade levels (such as grades 5, 7, and 10); percent of students passing all subject-area tests for specific grade levels (such as grade 12); attendance rate if elementary or middle school; and/or dropout rate if secondary school. Each data item has drill-down capability, which displays the underlying calculations and summary data.

The accountability status report and calculation worksheet are presented in PDF format in an embodiment that allows viewing online, downloading, and printing. In various embodiments, the data file indicates whether the school/system/state has met: proficiency targets on state assessments in reading and mathematics; proficiency targets, using confidence intervals, on state assessments in reading and mathematics, if needed; Safe Harbor in reading and mathematics, if needed; proficiency targets, using uniform averaging, on the state assessments in reading and mathematics, if needed; a 95% (or other programmable) participation rate for reading and mathematics; goals on the state assessments in science for specific grade levels (such as grades 5, 7, and 11); goals on the state assessments in writing for specific grade levels (such as grades 5, 7, and 10); percent of students passing all subject-area tests for specific grade levels (such as grade 12); attendance rate if elementary or middle school; dropout rate if secondary school.

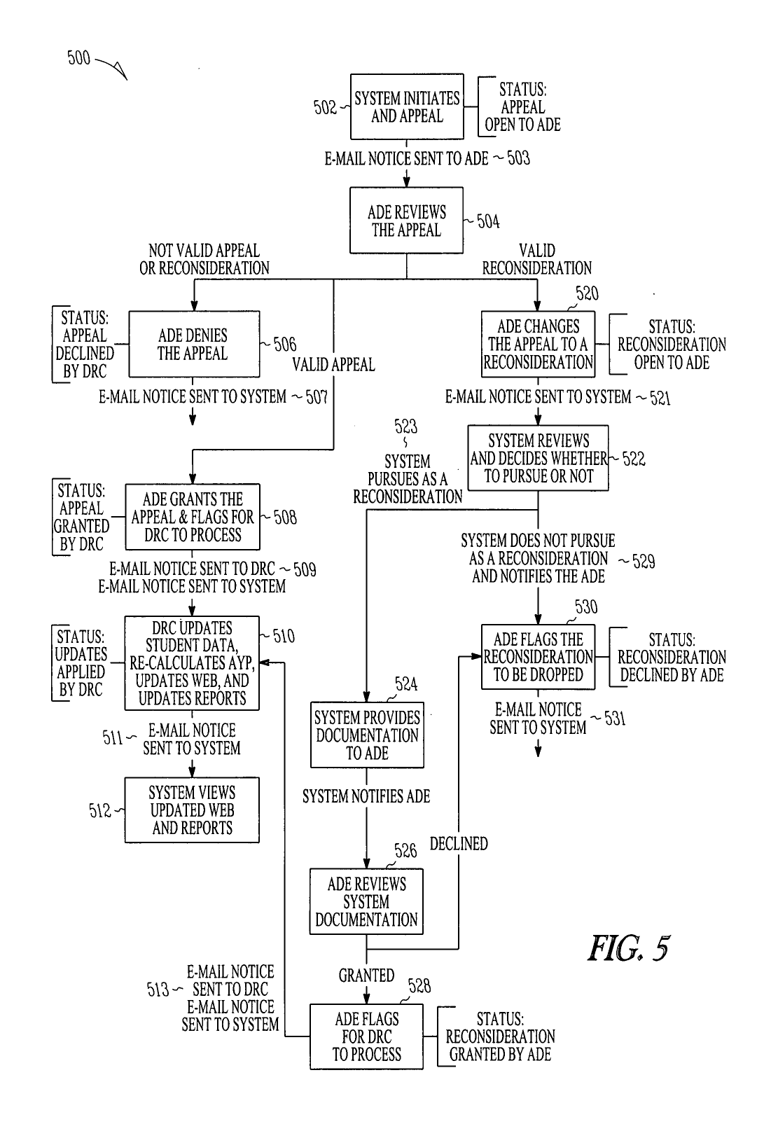

This web-based system also supports the appeals process. According to various embodiments, the system utilizes the following high-level process for handling appeals. First, an appeal is initiated and information entered on what status is being appealed and a brief rationale behind the appeal. Next, an e-mail is automatically sent to the ADE personnel alerting them that an appeal has been initiated. The district also sends the supporting documentation. The ADE reviews the documentation and updates in the web system whether the appeal is granted or denied. If granted, the data that are to be updated in the database are also documented. For appeals that are granted, the system updates the requested data, re-calculate AYP status, and re-generate all items posted on the website. An e-mail is sent to the school district and ADE personnel informing them that updated AYP status and reports are available on the website. The web-based site allows the ADE and the school district to simultaneously view the status of an appeal. The ability to generate a summary report of all appeals for the system or state is also provided. A more detailed depiction of the appeals process is provided with respect to FIG. 5, below.

Upon Close of the Appeals Window, Final AYP Status is Determined and Final Data Files and Reports Produced. (Step 16 and 17 in FIG. 1)

At the close of the appeals process, the system locks appeal initiation in the website, not permitting additional appeals to be initiated. At this point, all data and reports on the website reflect the final AYP status. These reports and data remain online and available for viewing, downloading, and printing.

Technical Report Produced and Provided to the School District.

Also at the end of each contract year, the system documents the AYP development in a report that is provided to the school district. This technical report documents the AYP calculation process and data verification procedures and can include the following items, in varying embodiments: formulas used for all calculations; summary of appeals applied; verification processes and procedures; data processing errors and corrective action taken

Software Quality Assurance Testing for Data Processing and Reporting

The systematic software and data testing approach ensures the school district accurate AYP results. To provide the school district with the highest level of accurate AYP results, a thorough evaluation of all data is conducted. File formats and data elements are validated against the school district approved layouts, specifications and processing rules for completeness and correctness. Detailed test scripts and test data are initially processed through each system to make certain that the data are properly calculated and the processing rules and requirements are applied accurately. In various embodiments, quality verification steps include: verification of enrollment and dropout rate data; verification of the participation rate; data corrections made by the systems; potential matched data; AYP proficiency results; Safe Harbor results; AYP results for each group; overall AYP status; appeals and recalculations to incorporate appeals; year-to-year AYP result comparisons; web systems and reports.

Testing involves processing sample student records through the accountability systems. Once standard compliance has been demonstrated, production data is generated through the systems to generate final AYP results. To reduce the risk of human error, each data record and report is carefully reviewed and evaluated programmatically to ensure it was calculated with 100 percent accuracy.

FIG. 5 shows a flow diagram of an adequate yearly progress (AYP) appeal/reconsideration process, according to one embodiment of the present subject matter. The method 500 includes initiating an appeal or reconsideration at 502, after which an e-mail notice is sent at 503 to the jurisdictional governing body (in the depicted embodiment, the body is the Alabama Department of Education (ADE)). The ADE reviews the request for appeal at 504. If the request is not a valid appeal or reconsideration, ADE denies the appeal at 506 and an e-mail reflecting this denial is sent from the ADE to the system at 507.

If the request is a valid appeal, the ADE grants the appeal and flags it for processing by the server host organization (in the depicted embodiment, the organization is Data Recognition Corporation (DRC)). An e-mail notice is sent to DRC and to the system at 509. DRC then updates the student data based on the successful appeal at 510, including recalculating AYP, updating the web and updating reports. An e-mail is sent to the system at 511, and the system views the updated web and reports at 512.

If the request is a valid reconsideration, the ADE changes the appeal to a reconsideration at 520 and sends an e-mail to the system at 521. At 522, the system reviews the reconsideration and decides whether or not to pursue it. If the system pursues the reconsideration at 523, documentation is provided to ADE at 524 and ADE reviews the documentation at 526. If granted, ADE flags it for DRC to process at 528, and sends an e-mail to DRC and the system at 513. If declined, or if the system does not pursue the reconsideration at 529, the ADE flags the reconsideration to be dropped at 530, and sends an e-mail to the system at 531. The appeal and reconsideration system thus provides notice to the jurisdictional governing body and the server host organization to expedite completion of the appeal and consideration process and to properly update the system and corresponding accountability data.

System Hardware

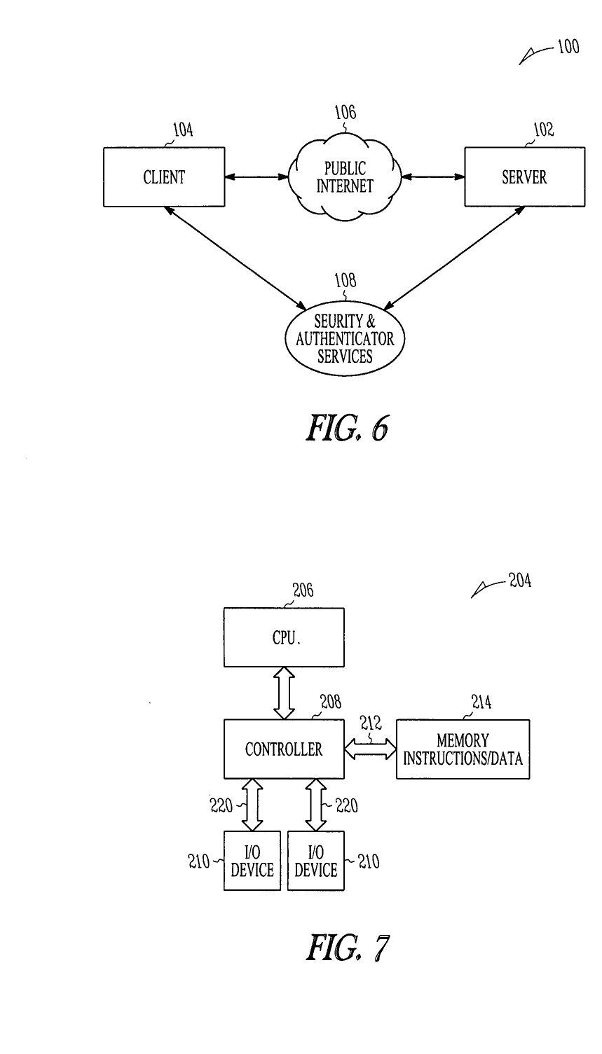

FIG. 6 shows a schematic diagram of a web-based computer client-server system for implementing an adequate yearly progress (AYP) appeal/reconsideration process, according to one embodiment of the present subject matter. The illustrated system 100 includes a server 102 at a first location and a browser-based client 104 at a second location. The client 104 communicates with the server 102. In one embodiment, the server 102 and client 104 communicate through the public Internet, illustrated as a network cloud at 106. Although only one client 104 and one server 102 are shown, one of ordinary skill in the art will appreciate that the system 100 is able to incorporate a number of clients and a number of servers. Security and authentication services, illustrated at 108, are used to secure the communication between the server 102 and the client 104. Examples of security services include, but are not limited to, firewalls and digital certificates.

In one embodiment, the client 104, illustrated at a remote location, is used to request information regarding educational accountability reporting and appeals. In one embodiment, the server 102 is located at or otherwise in communication with educational accountability reporting and appeals application such that the server is capable of receiving the request and providing the requested information.

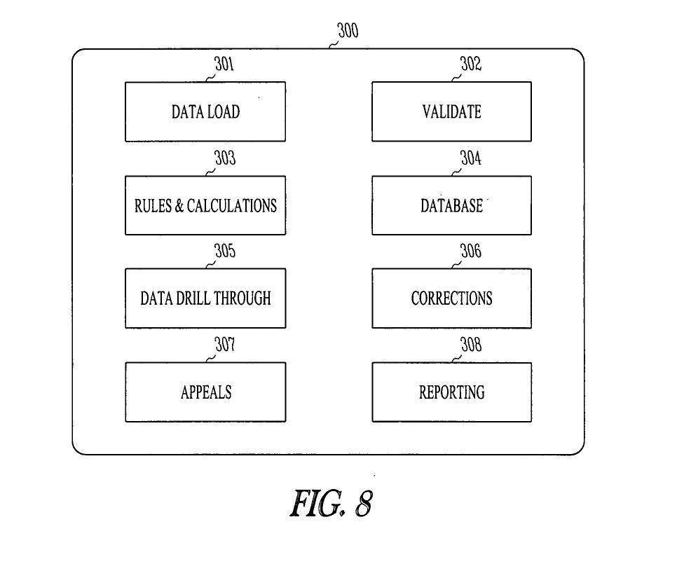

FIG. 7 shows a schematic diagram of a client system, according to one embodiment of the present subject matter. According to one embodiment, the client system includes a personal computer system. The illustrated client system 204 includes a central processing unit (CPU) 206, a controller 208, input/output (1/0) devices 210, and a memory 214 connected to the controller via a memory bus 212. The illustrated memory 214 holds instructions and data. According to various embodiments, examples of I/O devices 210 include monitors, keyboards, mice, video cards and USB devices. Controller 208 produces control and address signals to control the exchange of data between memory 214 and CPU 206, and between memory 214 and peripheral circuitry such as I/O devices 210. This exchange of data is accomplished over memory bus 212 and over I/O bus 220. Coupled to memory bus 212 are a plurality of memory slots which receive memory devices well known to those skilled in the art.

FIG. 8 shows a schematic diagram of a server system, according to one embodiment of the present subject matter. The illustrated server system 300 includes several program modules for implementing an adequate yearly progress (AYP) appeal/reconsideration process. The system contains a data load module 301, validate module 302, rules and calculations module 303, database module 304, data drill through module 305, corrections module 306, appeals module 307, and reporting module 308. All modules and data are stored in a memory, and a computer processor is used to execute the modules to manipulate the data. All modules work to perform various functions for the adequate yearly progress (AYP) appeal/reconsideration process, discussed above.

It is to be understood that the above description is intended to be illustrative, and not restrictive. The scope of the invention should, therefore, be determined with reference to the appended claims, along with the full scope of legal equivalents to which such claims are entitled.

What is claimed is:

1. A method, comprising:
storing collected data relating to student information for at least one school and at least one school district;
applying a plurality of rules to the information to generate a score indicative of progress for the at least one school and at least one district;
processing appeals relating to the score;
electronically mailing appeal information to one or more users; and
searching the stored data to obtain rule compliance data for the student information.

2. The method of claim 1, wherein applying a plurality of rules to generate a score includes generating a status summary.

3. The method of claim 2, wherein generating a status summary includes generating a summary including a plurality of data items, the items including proficiency targets, goals on state assessments, student pass rate, attendance rate or dropout rate.

4. The method of claim 3, wherein generating a summary including a plurality of data items includes providing the data items with drill-down capability to provide an option to display the underlying calculations and summary data.

5. The method of claim 2, wherein generating a summary includes providing a report in PDF format that allow viewing online, downloading, and printing.

6. The method of claim 1, further comprising:
providing access to the stored data to a state department of education.

7. The method of claim 1, further comprising:
testing to determine that standard compliance has been demonstrated before proceeding with production data.

8. The method of claim 7, wherein testing includes processing sample student records.

9. The method of claim 1, further comprising:
performing software quality assurance testing to ensure accurate AYP results.

10. The method of claim 9, wherein performing quality assurance testing includes validating file formats and data elements against school district approved layouts, specifications and processing rules for completeness and correctness.

11. The method of claim 9, wherein performing quality assurance testing includes verification of enrollment and dropout rate data.

12. The method of claim 9, wherein performing quality assurance testing includes verification of the participation rate.

13. A system, comprising:
means for storing collected data relating to student information for at least one school and at least one school district;
means for applying a plurality of rules to the information to generate a score indicative of progress for the at least one school and at least one district;
means for processing appeals relating to the score;
means for electronically mailing appeal information to one or more users; and
means for searching the stored data to obtain rule compliance data for the student information.

14. The system of claim 13, wherein the student information includes enrollment rate.

15. The system of claim 13, wherein the student information includes dropout rate.

16. The system of claim 13, wherein the student information includes attendance data.

17. The system of claim 13, wherein the student information includes assessment data.

18. A system, comprising:
an electronic database of information relating to student information for at least one school and at least one school district or system, the information comprising: enrollment rate; dropout rate; attendance data; and assessment data from standardized testing results; and
a computer processor adapted to apply a plurality of rules to the information to generate a score indicative of progress for the at least one school and at least one district, the processor further adapted to process appeals and to electronically mail appeal information to one or more users;
wherein the database is adapted to be searchable to provide rule compliance data for the student information.

19. The system of claim 18, wherein the processor is adapted to provide a technical report to document AYP calculation process and data verification procedures.

20. The system of claim 19, wherein the technical report includes formulas used for all calculations.

21. The system of claim 19, wherein the technical report includes a summary of appeals applied.

22. The system of claim 19, wherein the technical report includes verification processes and procedures.

23. The system of claim 19, wherein the technical report includes data processing errors and corrective action taken.
